(19) United States
(12) Patent Application Publication
(10) Pub. No.: US 2013/0101100 A1
(43) Pub. Date: Apr. 25, 2013

(54) INCENTING AND ENHANCING TELEPHONY SERVICE USAGE

(71) Applicant: Anantha Pradeep, Piedmont, CA (US)

(72) Inventor: Anantha Pradeep, Piedmont, CA (US)

(21) Appl. No.: 13/280,106

(22) Filed: Oct. 24, 2011

(51) Int. Cl. H04M 15/00

(52) U.S. Cl. 379/114.1

(57) ABSTRACT

Mechanisms are provided to incent and enhance telephony service usage. Telephony call setup requests are monitored at a system for incenting telephony service usage and participants in a telephony service usage incentive program are identified. The system may be associated with a telephony central office. If a particular caller or call setup request is associated with a milestone, such as every n^{th} caller or every m^{th} minute, corresponding to the incentive program, the caller is provided with an incentive award. Eligibility may be determined by identifying callers enrolled in a particular calling plan, callers having opted into receiving advertising during a call, and callers that have opted into call monitoring. Advertising may be provided before call connection, during, or after a call and selected advertising may be provided by determining caller characteristics and caller phone interaction information.

### TECHNICAL FIELD

The present disclosure relates to incenting and enhancing telephony service usage.

### DESCRIPTION OF RELATED ART

Conventional mechanisms for incenting and enhancing use of landline and mobile telephony services are limited. Some mechanisms include reduced per minute charges, reduced rate tiered calling plans, simplified calling plans, reduced cost long distance, prepaid calling cards, etc. Other mechanisms include improved telephony service accessibility particular in remote regions, high call quality, and improved telephony add-on services like call waiting, caller identification, and multi-party calling.

Nonetheless, in many geographic regions, telephony service usage is falling despite efforts to incent and enhance telephony service. In many instances, telephony service is being replaced with other modes of communication including data based communications such as instant messaging, social networks, email, etc. Consequently, it is desirable to provide improved mechanisms for increasing, enhancing, monetizing, and incentivizing use of telephony services, particularly when existing infrastructure supports increased usage.

Techniques and mechanisms for incented telephony service monitoring are provided.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of network that can use the techniques and mechanisms of the present invention.

FIG. 2 illustrates one example of a mechanism for incenting telephony service usage.

FIG. 3 illustrates another example of enhanced telephony services.

FIG. 4 illustrates a particular example of a technique for selecting incentives and materials for a particular telephony service user.

FIG. 5 illustrates a particular example of a server.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques and mechanisms of the present invention will be described in the context of particular servers and telephony networks such as public switched telephone networks (PSTNs). However, it should be noted that the techniques and mechanisms of the present invention apply to a variety of different servers and networks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Mechanisms are provided to incent and enhance telephony service usage. Telephony call setup requests are monitored at a system for incenting telephony service usage and participants in a telephony service usage incentive program are identified. The system may be associated with a telephony central office. If a particular caller or call setup request is associated with a milestone, such as every n^{th} caller or every m^{th} minute, corresponding to the incentive program, the caller is provided with an incentive award. Callers or call setup requests near the milestone are provided with an indication of proximity to the milestone. Eligibility may be determined by identifying callers enrolled in a particular calling plan, callers having opted into receiving advertising during a call, and callers that have opted into call monitoring. Advertising may be provided before call connection, during, or after a call and selected advertising may be provided by determining caller characteristics and caller phone interaction information.

### Example Embodiments

Current techniques for promoting use of landline and mobile telephony services are limited. Conventional techniques tend to revolve around monetary incentives and quality of service based incentives. Monetary incentives include reduced rate calling plans, tiered calling plans, simplified services, reduced cost long distance, prepaid calling cards, etc. Quality of service based incentives include improved telephony service accessibility particularly in remote regions, high call quality, and improved telephony add-on services like call waiting, caller identification, and multi-party calling.

Nonetheless, in many geographic regions, telephony service usage is falling. In many instances, telephony service is being replaced with other modes of communication including data based communications such as instant messaging, social networks, email, short message services, etc. Consequently, the techniques and mechanisms of the present invention provide improved mechanisms for increasing, enhancing, monetizing, and incentivizing use of telephony services, particularly when existing infrastructure supports increased usage.

According to various embodiments, the total number of calls in a particular network is continuously monitored. Incentives, including monetary incentives are provided to every n^{th} caller. In some examples, one hundred credits may be provided to every thousandth caller. Callers close to being the thousandth caller may be notified after dialing and partial call connection but prior to full call connection. In other examples, one hundred thousand credits may be provided to every millionth caller as detected by an incentive monitoring system connected to a telephony network central office, while smaller monetary incentives may be provided at particular milestones leading up to an n^{th} caller. According to various embodiments, callers that opt in to a particular calling plan, a particular amount of advertising exposure, call monitoring and call characteristic profiling, etc. In other examples, callers may qualify for incentives including monetary rewards by making a certain number of calls or using a certain number of minutes per month.

In particular embodiments, callers that come close to obtaining a particular monetary incentive are informed that their calls were close. The information may come at the beginning or end of a particular call in the form of an audio announcement. According to various embodiments, audio announcements can also be used to provide information, advertisements, offers, etc. In particular embodiments, targeted advertisements are provided based on caller profile information. The caller may agree to provide preference information, demographic data, call histories, interests, etc., and this information can be used to select audio advertisements, offers, or information for a particular caller. Caller phone interaction characteristics can also be used to identify information about a particular caller. For example, how quickly a caller dials, how many errors are made in dialing, how loud a caller talks, how frequently calls are made, when calls are made, etc., can all be used to identify characteristics about a particular caller. This caller phone interaction characteristic information need not even be consciously conveyed, but instead is typically provided subconsciously and detected automatically by a telephony system.

In some examples, if a caller is a particular slow dialer and calls mostly during daylight hours, slower paced advertising may be provided. Alternatively, if a caller speaks rapidly and dials quickly, faster paced advertising may be provided. In particular jurisdictions, opt ins may be required to obtain caller characteristics information. In particular embodiments, audio advertisements may be presented while a caller is waiting for a call to connect, or after a call is complete. Incentives may also be provided to a caller for listening to a complete advertisement. Incentives may be supported by particular rate plans or advertising revenue.

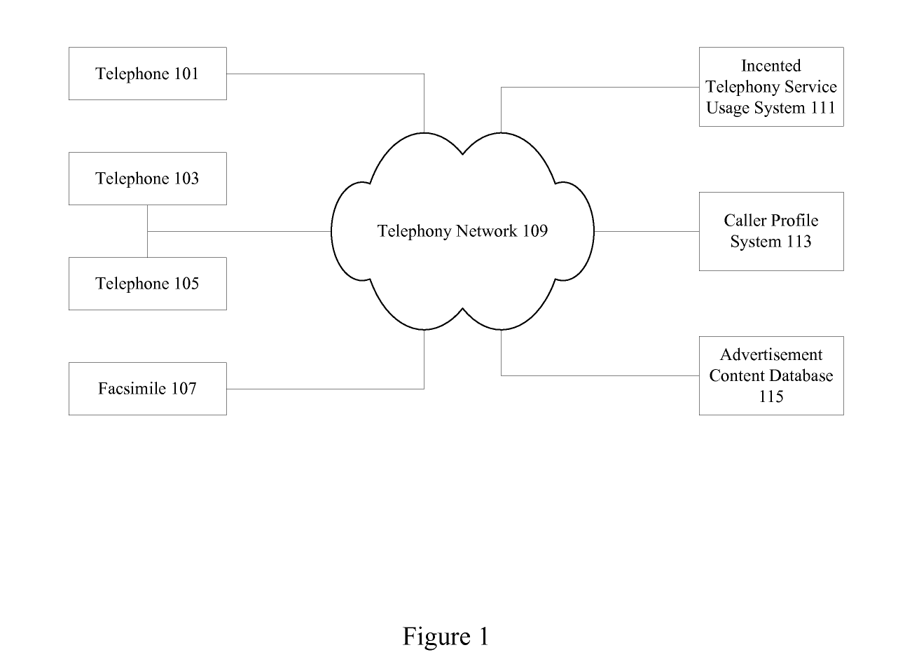

FIG. 1 illustrates one example of system for incenting telephony service usage. According to various embodiments, telephone 101, telephone 103, telephone 105, and facsimile (fax) machine 107 are connected to a telephony network such as a public switched telephone network (PSTN). An incented telephone service usage system 111 is connected to PSTN 109 and monitors call activity from telephones 101, 103, and 105 as well as fax machine 107. According to various embodiments, the incented telephony service usage system 111 is also connected to a caller profile system 113 that provides information on particular callers or devices so that advertising can be selectively obtained from advertisement content database 115. In particular embodiments, the incented telephony service usage system 111 monitors call activity to determine if a particular call has been made at a particular milestone, such as every millionth call. The incented telephony service usage system 111 also determines what callers may have opted in to a particular incentive program or opted to receive advertising to be included in the program.

According to various embodiments, the caller profile system 113 identifies caller characteristics information. Some caller profile information may be manually provided by a caller. Other caller information profile information may be obtained based on the way a particular caller interacts with a telephone, e.g. dialing speeds, talking speeds, call frequency, etc. Based on caller characteristics information, advertising may be selected from an advertisement content database 115. Advertisements may be provided in audio form to particular telephone users. It should be noted that even though conventional plain old telephone service (POTs) telephones are shown, various techniques and mechanisms can also be applied to mobile devices, internet protocol (IP) phones, etc. However, various techniques and mechanisms are particularly useful for POTs lines because POTs calls conventionally do not provide much information about a caller and there are limited mechanisms for incenting POTs line usage. Advertising is also not typically provided to a caller by an entity associated with the network. Advertising may be provided by a party at the other end of a call, but is not typically provided by a network mechanisms or service provider.

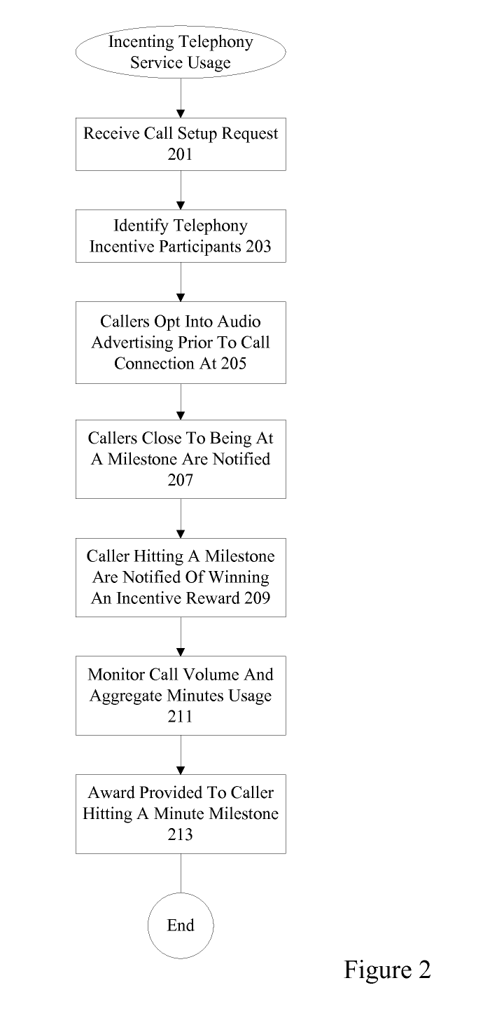

FIG. 2 illustrates one example of a mechanism for incenting telephony service usage. According to various embodiments, a call setup request is received at 201. In particular embodiments, an incentive structure is identified. The incentive structure may provide awards at particular milestone, e.g. for every n^{th} caller and premium rewards for every m^{th} caller where m is greater than n. At 203, telephony incentive participants are identified and notified. Telephony participants may opt into a particular incentive program by signing up for a particular calling rate plan. Alternatively, callers may elect to participate in the incentive program by opting into audio advertising played during a 3-5 second period prior to call connection at 205. Callers that are identified as participating in the program are selected for to hear audio advertisements or other types of offers and services. At 207, callers close to being at a milestone such as an n^{th} or m^{th} caller are notified that they were close to winning an incentive reward. At 209, an n^{th} or m^{th} is notified of actually winning an incentive reward.

Incentives may include free minutes, cash, prizes, awards, points, etc. According to various embodiments, instead of providing incentives to an n^{th} caller, incentives are provided to callers who use an n^{th} minute. In particular embodiments, a system for incenting telephony service usage may monitor minutes usage and provide incentives every millionth minute of aggregate usage at 211. This would encourage not only call volume, but increase call duration. In particular embodiments, the system for incenting telephony service usage monitors aggregate minutes usage since a last payout and will provide an audio indicator to current callers when an n^{th} minute is near. According to various embodiments, an audio award indicator will be provided to a caller that actually is still on a call during the n^{th} minute trigger at 213.

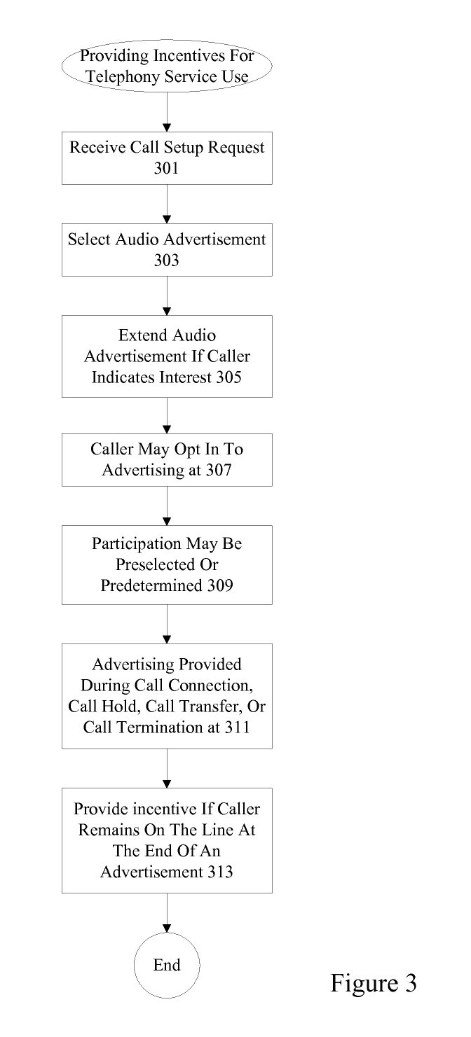

FIG. 3 illustrates a particular example of a technique for providing incentives for telephony service use. According to various embodiments, a call setup request is received or detected at 301. Instead of immediately attempting to connect the call, an audio advertisement of appropriate length is selected at 303. In some examples, the audio advertisements may last up to 30 seconds and extend longer if a particular caller expresses interest by way of voice of keypad response at 305. According to various embodiments, a caller may select whether to listen to an advertisement at 307 in return for being able to participate in an incentive program. In other examples, participation in the incentive program and listening to advertisements may be preselected or predetermined at 309.

According to various embodiments, audio advertisements may be provided when a caller initiates a call, when a caller is placed on hold at or is being transferred to another line, or at the end of a call at 311. According to various embodiments, advertisements, offers, and services can be provided at the end of a call after a caller on the other end disconnects. According to various embodiments, an incentive may be provided if the caller remains on the line during the duration of an audio advertisement at the end of a call at 313.

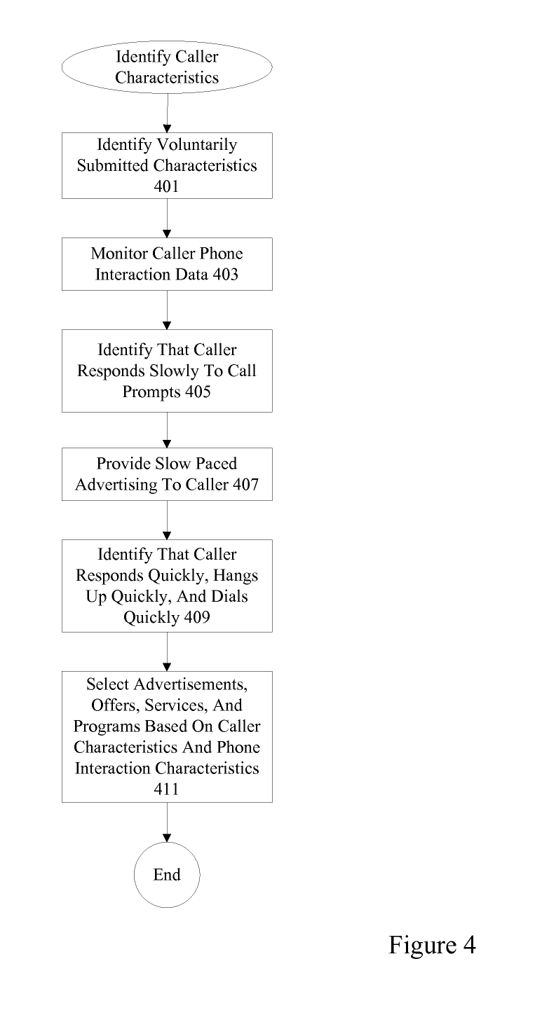

FIG. 4 illustrates a particular example of a technique for identifying caller characteristics. According to various embodiments, caller voluntarily submitted characteristics at identified at 401. In some examples, caller submitted characteristics may include profile and demographic information provided when a caller subscribes to a calling plan. This information may include age, ethnicity, location, income, interests, etc. At 403, caller phone interaction characteristics are monitored. In some examples, phone interaction characteristics may include how quickly a caller dials, the amount of hesitation between key presses, how quickly a caller hangs up after a busy signal or call completion. Caller phone interaction characteristics provide information about a caller's personality, temperament, and age. Although this information may not be completely accurate, it can provide some guidance in selecting messages appropriate for a caller. For example, if a particular caller is known to respond slowly to call prompts 405, slow paced advertising may be provided to the caller at 407.

Alternatively, if the particular caller is known to be impatient and hangs up quickly and dials quickly at 409, fast paced advertising or advertising suited to busy individuals may be provided at 409. In particular embodiments, the types of calls and destinations of calls are identified to provide caller interest information. For example, a system for incenting and enhancing telephony services may determine that a caller has been calling general contractors. Advertisements pertinent to this interest may be provided. According to various embodiments, advertisements, offers, services, programs, are selected based on caller characteristics such as caller submitted characteristics or caller phone interaction characteristics at 411.

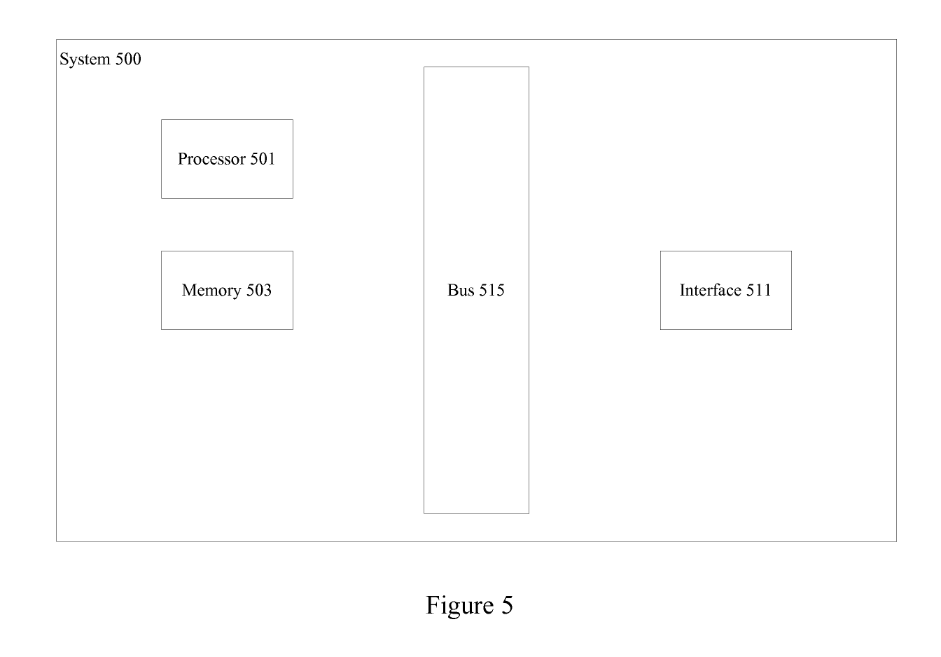

FIG. 5 illustrates a particular example of a server that can be used to incent and enhance telephony service usage. A variety of devices and systems can implement particular examples of the present invention. According to particular example embodiments, a system 500 suitable for implementing particular embodiments of the present invention includes a processor 501, a memory 503, an interface 511, and a bus 515 (e.g., a PCI bus). The interface 511 may include separate input and output interfaces, or may be a unified interface supporting both operations. When acting under the control of appropriate software or firmware, the processor 501 is responsible for such tasks such as optimization. Various specially configured devices can also be used in place of a processor 501 or in addition to processor 501. The complete implementation can also be done in custom hardware. The interface 511 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 900 uses memory 903 to store data and program instructions and maintained a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A system for incenting telephony service usage, comprising:
an interface configured to receiving a telephony call setup request;
a processor configured to identify a caller associated with the call setup request and determine that the caller is a participant in an incentive program associated with telephony service usage;
wherein if the caller and the call setup request is associated with a milestone corresponding to the incentive program, an incentive award is provided to the caller.

2. The system of claim 1, wherein if the caller and the call set up request is associated with a point near the milestone, an audio indication is provided to the caller.

3. The system of claim 1, wherein the milestone is every n^{th} call.

4. The system of claim 1, wherein the caller is a participant if the caller has opted in to a particular calling plan having incentive awards.

5. The system of claim 1, wherein the caller is a participant if the caller has opted in to receive advertising provided during calls.

6. The system of claim 5, wherein advertising is selected based on caller submitted characteristics.

7. The system of claim 5, wherein advertising is selected based on caller phone interaction characteristics.

8. The system of claim 7, wherein caller phone interaction characteristics comprise dialing speed.

9. The system of claim 7, wherein caller phone interaction characteristics comprise call frequency.

10. The system of claim 5, wherein advertising is selected based on call destinations.

11. The system of claim 1, wherein the caller is a participant if the caller has opted into call monitoring.

12. A method, comprising:
receiving a telephony call setup request at a system for incenting telephony service usage;
identifying a caller associated with the call setup request;
determining that the caller is a participant in an incentive program associated with telephony service usage;
determining whether the caller and the call setup request is associated with a milestone corresponding to the incentive program.

13. The method of claim 12, wherein if the caller and the call setup request is associated with the milestone, providing an incentive award to the caller.

14. The method of claim 12, wherein if the caller and the call set up request is associated with a point near the milestone, an audio indication is provided to the caller.

15. The method of claim 12, wherein the milestone is every n^{th} call.

16. The method of claim 12, wherein the caller is a participant if the caller has opted in to a particular calling plan having incentive awards.

17. The method of claim 12, wherein the caller is a participant if the caller has opted in to receive advertising provided during calls.

18. The method of claim 17, wherein advertising is selected based on caller submitted characteristics.

19. The method of claim 17, wherein advertising is selected based on caller phone interaction characteristics.

20. The method of claim 19, wherein caller phone interaction characteristics comprises dialing speed.

21. The method of claim 19, wherein caller phone interaction characteristics comprises call frequency.

22. The method of claim 17, wherein advertising is selected based on call destinations.

23. The method of claim 12, wherein the caller is a participant if the caller has opted into call monitoring.

24. A non-transitory computer readable storage medium, comprising:
computer code for receiving a telephony call setup request at a system for incenting telephony service usage;
computer code for identifying a caller associated with the call setup request;
computer code for determining that the caller is a participant in an incentive program associated with telephony service usage;
computer code for determining whether the caller and the call setup request is associated with a milestone corresponding to the incentive program.
